(19) United States
(12) Patent Application Publication
(10) Pub. No.: US 2020/0207606 A1
(43) Pub. Date: Jul. 2, 2020

(54) SMART FUELING ELBOW

(71) Applicants: Gözde BULGURCU BILGEN, Istanbul (TR); Berkehan BULGURCU, Konya (TR)

(72) Inventors: Gözde BULGURCU BILGEN, Istanbul (TR); Berkehan BULGURCU, Konya (TR)

(21) Appl. No.: 16/632,359

(22) PCT Filed: Jul. 20, 2018
(86) PCT No.: PCT/TR2018/050390

§ 371 Date: Jan. 19, 2020

(30) Foreign Application Priority Data
Jul. 20, 2017 (TR) 2017/10647

(51) Int. Cl. B67D 7/34; G01N 11/10

(52) U.S. Cl. CPC B67D 7/342; G01N 11/10

(57) ABSTRACT

The invention includes a device (205) which prevents situations of fueling incorrect or poor-quality fuels to the tanks during fueling to the storage tanks (210) at fueling stations (200), by analyzing fuel quality and fuel type considering many physical parameters with the help of a sensor (504) that is consist of mechanical resonators, and a smart fueling elbow which has mobile characteristics making possible for the user to carry the elbow to the usage field.

### TECHNICAL FIELD

The invention is about a smart fueling elbow which prevents situations of fueling incorrect or poor-quality fuels to the tanks during fueling to the storage tanks (210) at fueling stations (200), by analyzing fuel quality and fuel type considering many physical parameters with the help of a sensor (504) that is consist of mechanical resonators, and a smart fueling elbow which has mobile characteristics making possible for the user to carry the elbow to the usage field.

### KNOWN STATUS OF THE TECHNIQUE

Liquid hydrocarbons formed by the transformation of organic material in layers of the soil and the stored in these layers is called as crude petroleum. The expression “crude” in the phrase of crude petroleum gives an impression that it is a raw material and is not processed. Crude petroleum is decomposed (distilled) in the refineries and converted into many intermediates and fuel products that are offered for the daily use.

As a result of processing and decomposition of the crude petroleum in the refineries, on average, 43% gasoline, 18% fuel oil and diesel fuel, 11% LPG (liquefied petroleum gas, propane or propane-butane mixture), 9% jet fuel, 5% asphalt and 14% other products are obtained. Some of these products are used for land vehicles, some for air vehicles and others for other operations. The crude petroleum outputs for land vehicles are usually gasoline, diesel fuel and LPG. These products are usually transported from the refineries by land, preferably by tankers and distributed to fueling stations.

There are usually one or more reservoirs in the tanks in tankers carrying from the refineries to the fueling stations. These reservoirs are designed so that the fuel is not mixed with each other and each reservoir is filled with a different fuel (gasoline, diesel fuel, etc.) and the tanker is transported to the fueling station in this way. There are more than one reservoirs in tankers and there are more than one depots in fueling stations to store the fuel oil. Each tank is filled with a different type of fuel and the distribution is carried out from that tank. These depots are located underground and/or on the ground at fueling stations and there is the filling point in which the filling mouths are located near and/or far from the tank hatch.

When the tanker arrives to the fueling station after filling the reservoirs in the refinery and a transfer to the depots in the fueling station is preferred, a flow path between the tanker and depots is formed, and by this flow line with the help of gravity and pump, the fuel in the tanker's reservoir is transferred to the fuel depots.

Nowadays, the flow line used for this operation is provided by an elastic hose which has a connection point on both sides. One end of the elastic hose is connected to the outlet of a reservoir in the tank by an employee and the other end of the hose is connected to the mouth of the tank in which the fuel is stored, and thus the transfer is performed in this manner. In the present technique, this process is carried out entirely at the initiative of one employee. This situation causes some serious risks to occur. The most common risk is that a terminal which is connected to a fuel tank having one type of fuel is connected in the other end to a different fuel in the fuel depot. As a concrete example of this situation; connecting the diesel fuel end of the flow line in the tank to the gasoline fuel tank in the other end of the depot of the fueling station and then transferring it. In this situation, diesel fuel flow line in one reservoir of the tanker is transferred to the depot of the gasoline and thus there will be a mixture of diesel fuel and gasoline in the gasoline depot. When the diesel fuel and gasoline is mixed, since it is not possible to separate these two fuels, it is necessary to clean the depots in which the mixture occurs and the fuels shall be out of usage.

The cleaning process is costly and time consuming. In addition to that, if the fuel mix is not noticed, mixed fuels can be transferred to the fuel tanks of the vehicles deposits via the pumps. If a mixture of fuels is transferred into a vehicle which works with one type of fuel and this mixture is injected into the engine, then the vehicle may be seriously damaged. For this reason, it is very crucial that both ends of the flow line are connected in the correct reservoir and storage.

In the current state of the art, patent GB2487311, there are fuel identification sensors in the fuel delivery system at the transfer pipes and the connection points. These sensors provide identification of the fuel with an optical sensor. The calculation made with optical sensor technology identifies and detects the fuel type by considering the refractive index of the liquid. The type of the liquid is directly related to the color of the liquid. The option that the optical sensors are mobile or fixed increases the cost and this increases the maintenance costs.

The present state of the art, patent AU2007200878, has a unit for storing data in fuel pipes. The term “data” refers to fuel type. The data are compared when the pipes where the fuel type is recorded meet each other. When the data are matched, the appropriate signal is given, and when it does not match, the warning signal is given or the transfer is blocked. This system requires high amount of attention. The data must be updated before each transfer.

In the current state of the art, patent WO2014165569, a determination of the quality of the fuel in the oil wells is achieved by the optical sensor method.

### Technical Problems that the Invention Aims to Solve

During the fuel transfer to the depots in the fueling stations, the present invention which is about a smart fueling elbow which prevents the situations of fueling incorrect or poor quality fuels to the tanks, during fueling to the depots at fueling stations, by analyzing fuel quality and fuel type considering many physical parameters with the help of a sensor consist of mechanical resonators, which has mobile characteristics making possible for the user to carry the elbow to the usage field, is entirely free of the above disadvantages, and characterized by; a sensor for analyzing the type and quality of the fuel in a smart fueling elbow that physically analyzes many parameters (viscosity, density, di-electric constant, temperature), and said sensor comprising mechanical resonators and measuring based on the response of the resonator in the liquid, directing the flow through the flow control valve, which operates based on the received data, being mobile and that the energy need is guaranteed by long-lasting batteries without the need for an electrical connection.

In a smart fueling elbow; the reference parameters of the liquid to be transferred onto the device can be defined according to the purpose of use and the type of liquids to be transferred. According to the defined reference values, information about whether or not the transfer process is correct is given from the visual warning or audible warning leds on the appropriate liquid led, inappropriate liquid led and an error led.

The flow control valve included in the invention automatically performs the flow transfer according to the command received from the control unit or, if the control unit does not approve the liquid transfer, the flow control valve ensures that the liquid filling the device remains within the device.

The liquid flow can be observed from the flow control pane during the transfer. The invention has the advantage that it is able to understand what kind of fuel the filling point belongs to, depending on the magnetic sensor and the pole of the magnet located at the filling port. As an advantageous point, a meter can be added to measure the amount of liquid transferred to the device.

By virtue of the wireless data transfer transmitter on a smart fueling elbow, it can transmit instant data by communicating with receivers of a center or mobile terminal A smart fueling elbow keeps data collected during fluid transfers by date and number on the data storage unit. A smart fueling elbow can also perform analysis of many fluids, other than the fuel types.

A smart fueling elbow, removes the disadvantages of the relative parameter, as in the optical sensor in existing systems, eliminating the disadvantages of a relative parameter and measuring it from four different physical parameters and controlling liquid flow by analyzing the quality of the liquid as well as identifying the liquid type. The sensor can directly and simultaneously measure the viscosity, density, dielectric constant and temperature of fluids. Advantageously, the sensor can also measure the desired measurements separately as well as measuring the viscosity of the fluid, the density of the dielectric constant and temperature together. As a further advantage, the sensor analyzes the viscosity, the density, the dielectric constant and the temperature values continuously by repeating measurement within certain periods. During the acquisition of these measurements, the sensor checks the values simultaneously and analyzes the results.

The sensor operates with the principle of “vibration”, has a light and simple structure in semi-digital and in small size, and has high sensitivity and reliability. The sensor comprises a lower portion and the first and the second vibrating arms extending towards the first direction from the lower portion. In order to increase the measurement performance as another advantage, high-speed digital circuits and digital signal processing technology are used instead of the conventional analog control system in the transmitters.

The sensor directly takes the liquid density and the detector sends the analog signal carrying the measurement information to the prerequisite circuit for amplification and filtering. Then the analog-to-digital converter converts the amplified and filtered analog signal into a digital signal, and the closed-loop control unit tracks the signal frequency of the control phase difference and amplitude. From this, the intensity value is measured.

The sensor controls the amount of electricity required to move a certain fixed frequency with the vibrating plates. Since the frictional force is directly proportional to the viscosity of the liquid, the amount of electrical power required to move the sensor plates to a constant frequency is proportional to the viscosity. The viscosity value is measured by this proportionality.

The sensor can measure the temperature of the liquid by the temperature sensor on it. As an advantageous point, the sensor can determine the nature of the fluid using data obtained by measuring the viscosity, density, dielectric constant, and temperature of the fluid. In determining the type of liquid, the sensor takes the data defined for that liquid as reference, the values obtained at the end of the measurement are compared with the reference values. If the measured values fall within the range of values set for the liquid, thus the type of liquid is determined by this way. If the values do not fall within the values defined for that liquid, it is inferred that the liquid should be a different liquid.

As an advantageous point, the sensor has the ability to allow the passage of the liquids it identifies. If the control unit confirms the liquid transition analyzed by the sensor, it sends a signal to the motor in the system to allow the flow control valve to open and to flow through the liquid flow path. In this situation, a visual warning is given by the confirmation leds on the flow control screen. If the control unit does not approve the flow of the liquid analyzed by the sensor, the flow control valve in the system remains closed and the flow of liquid through the flow path is not allowed. In this situation, the visual and audible warnings are given from the flow control screen. The sensor prevents the passage of the incorrect fluid through the flow path by not permitting the passage of liquids which are incorrect or undesirable to pass through to other side. The motor in the system allows to let the liquid flow by opening the valve with the command it receives from the sensor.

By the compact structure of the sensor, the measurement reliability of the system is ensured. Due to the mounting structure of the sensor, necessary measures have been taken for sealing. The sensor is made of materials resistant to deformations caused by fluids, taking into account that the deformations that the material can cause.

The sensor allows the viscosity of the fluid obtained from the liquid, the density, the di-electric constant and temperature values to be stored by sending to the data source of the system. These values are stored together with the date and time information, allowing the reading of these values backwards.

The sensor can transmit the viscosity, the density, the di-electric constant and the temperature values of the fluid it measures to the tablet, computer or handset by wireless communication methods. These values can be monitored instantaneously.

If the sensor detects that the liquid is not the correct liquid, the led on the display screen indicates that the correct fuel is not available. If the liquid that is measured is the correct liquid, the led on the display indicates that the liquid is the correct liquid.

As an advantageous point, the system can be used as mobile. By the help of the pole position of the magnet in the tank filling mouths, the type of liquid to be filled in the tank can be determined.

The filling mouth is the part of the fueling elbow at the entrance of the tank to be filled. A magnet is positioned at the filler mouth to define the filling port of the system and the tank to be drained through it. The pole of the magnet at the filling mouth is determined by the sensor in the fueling elbow. By the fuel type defined in the position of this magnet, a controlled discharge of the liquid to be supplied from the filling mouth is provided. The fueling elbow does not work if the fueler which is attached to the mouth which has no magnet. In this regard, the fueling elbow permits the discharge of fuel to the defined tanks only at the defined filling port.

### DESCRIPTION OF THE FIGURES

FIG. 1—The general view of the assembly of the fueling elbow on the line.

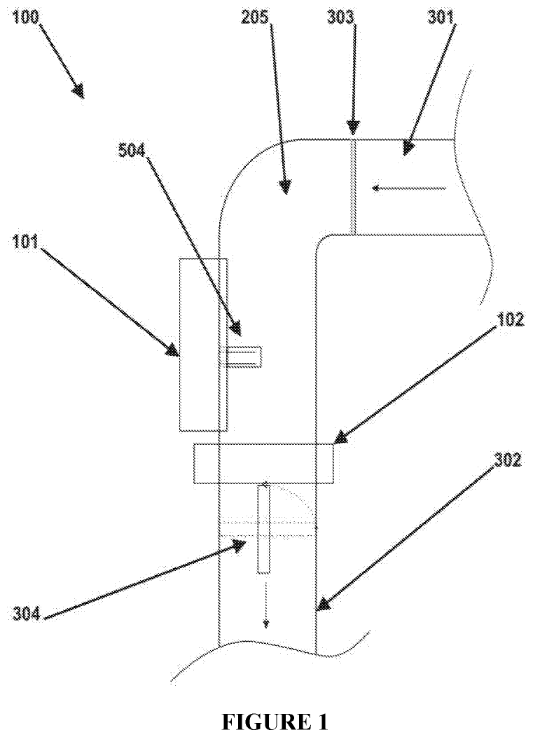

FIG. 2—The general view of the structure of the sensor (a) and the display of the sensor on the line (b).

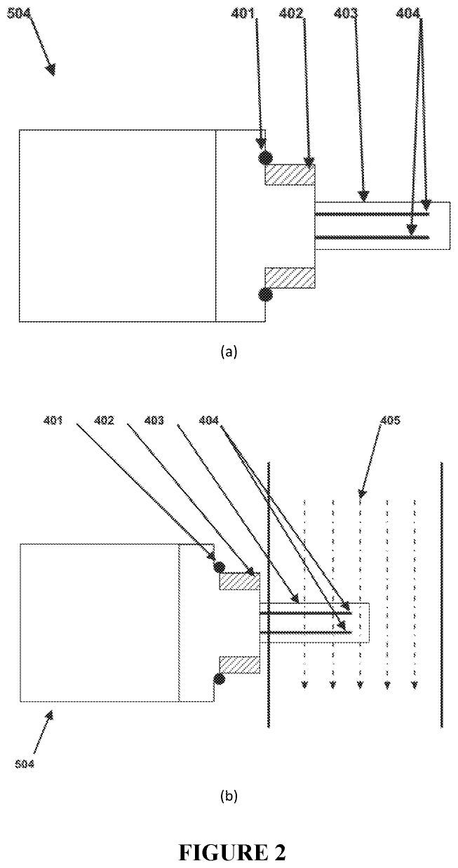

FIG. 3—The block diagram of the digital closed-loop control system.

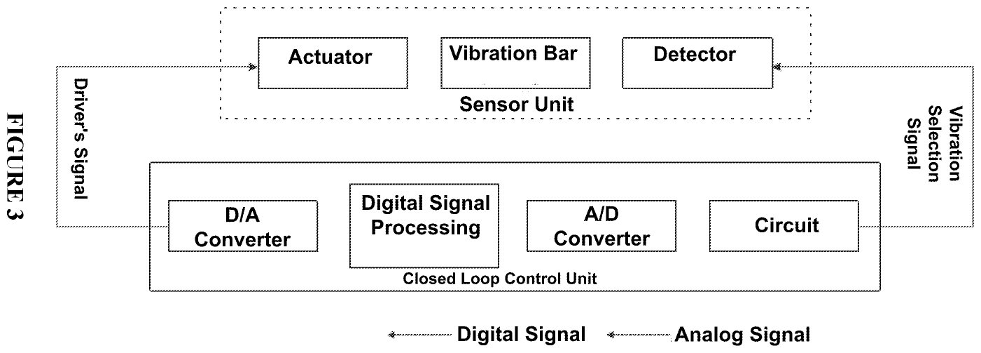

FIG. 4—The general view of the sensor and flow control valve.

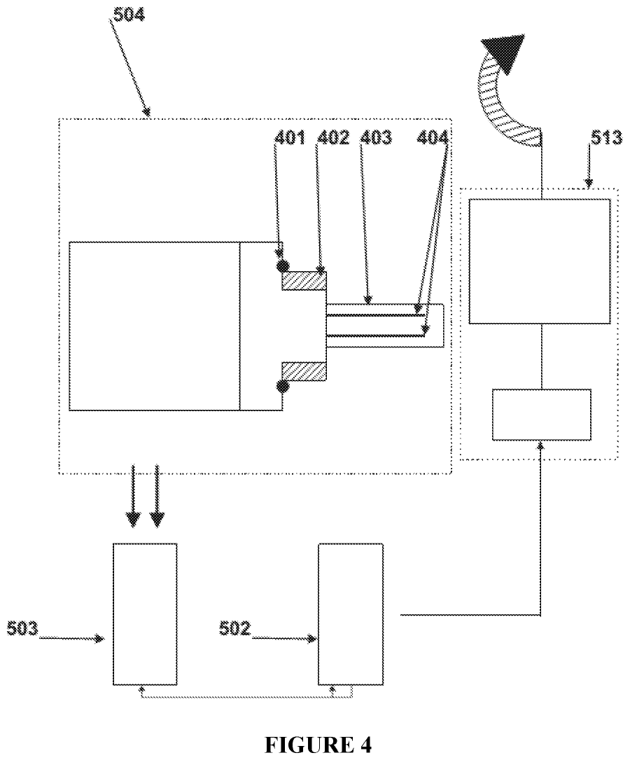

FIG. 5—The general view of a schematic representation of a fuel station in which the respective devices and parts are shown.

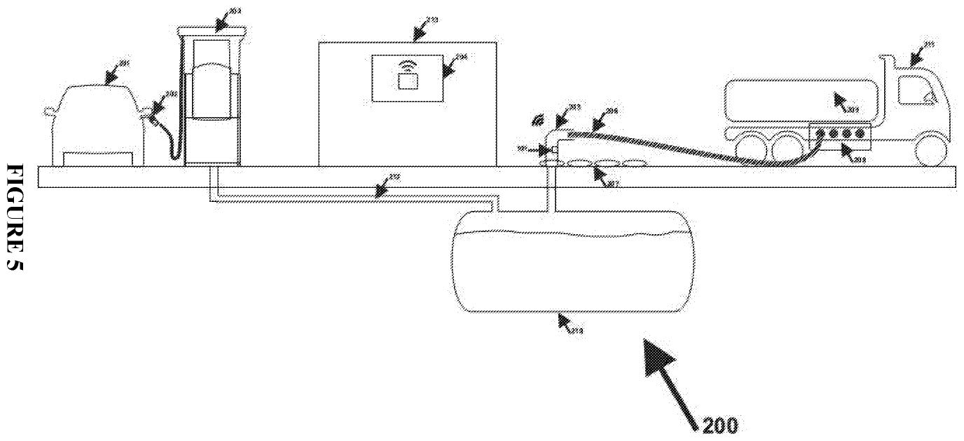

FIG. 6—The general view of the fueling elbow.

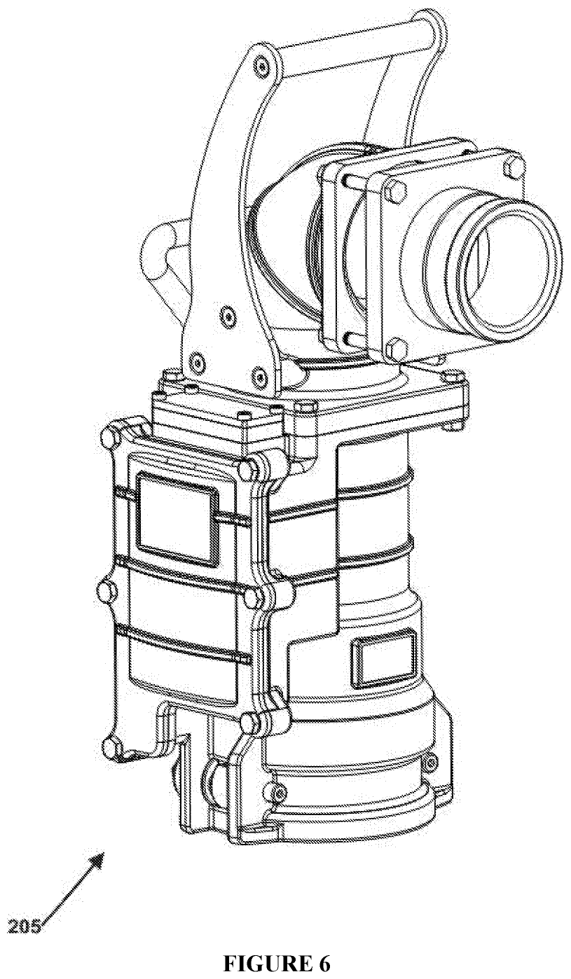

FIG. 7—The general view of the fueling elbow when the hatch is removed.

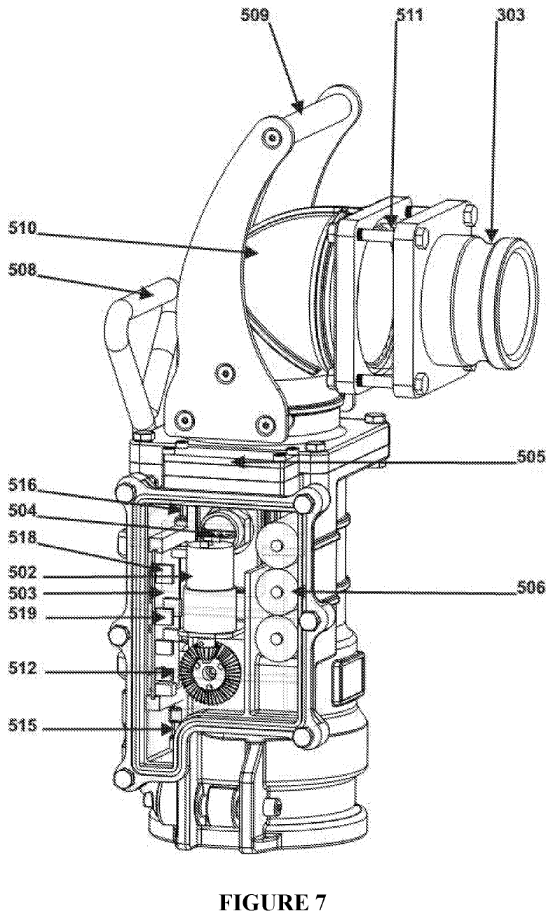

FIG. 8—The cross-sectional view of the filling circle.

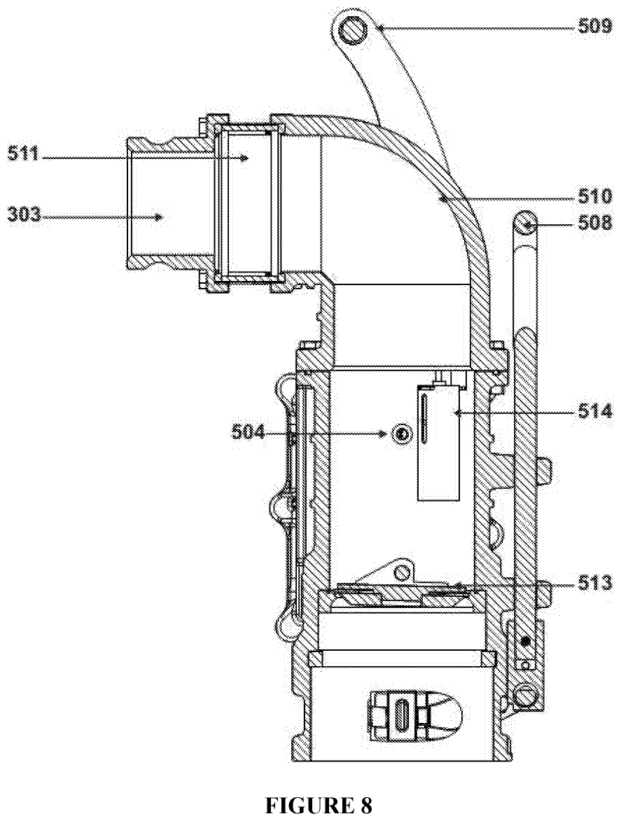

FIG. 9—The perspective view of the filling mouth used in the assembly of the fueling elbow.

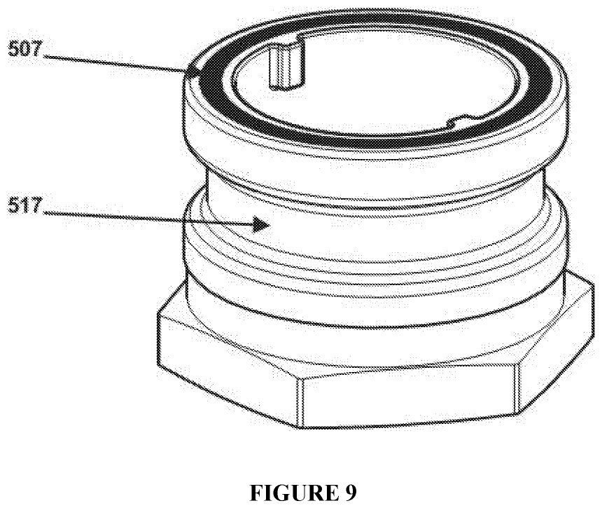

FIG. 10—The schematic view of oscillation modes of vibration fork at the sensor.

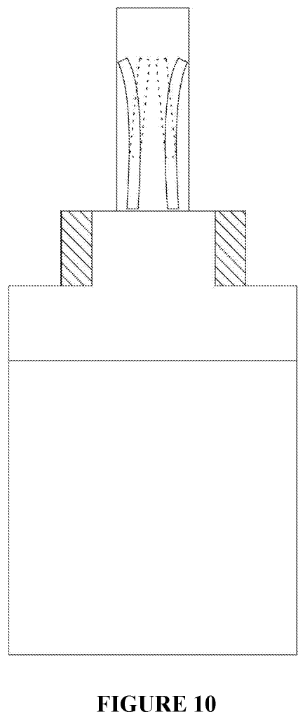

FIG. 11—The schematic view of the general circuit of the sensor.

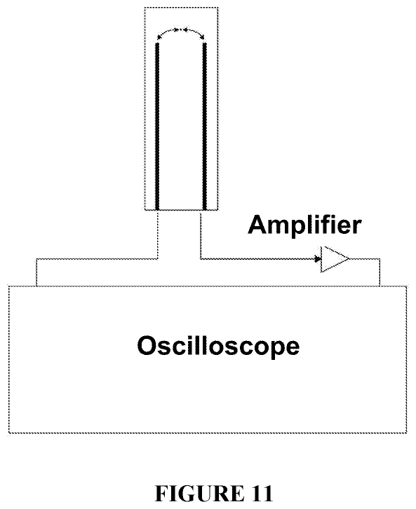

FIG. 12—The schematic view of the control unit.

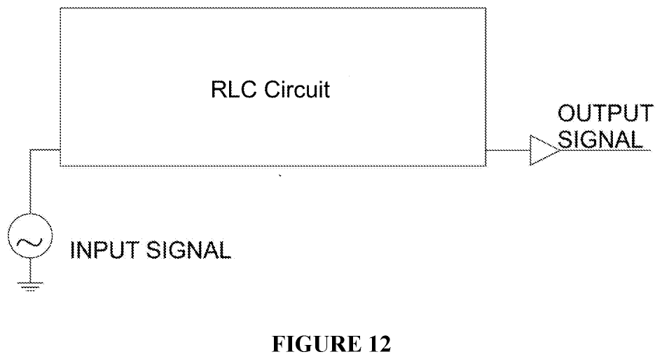

FIG. 13—The diagram showing the fuel type difference according to the viscosity values taken from the sensor.

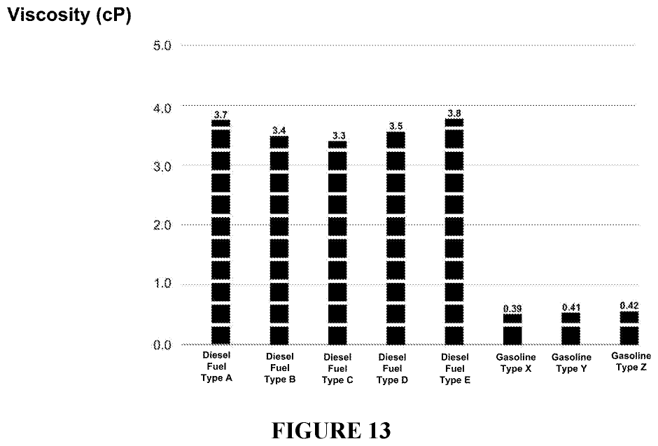

FIG. 14—The diagram showing fuel type difference according to di-electricity values taken from the sensor.

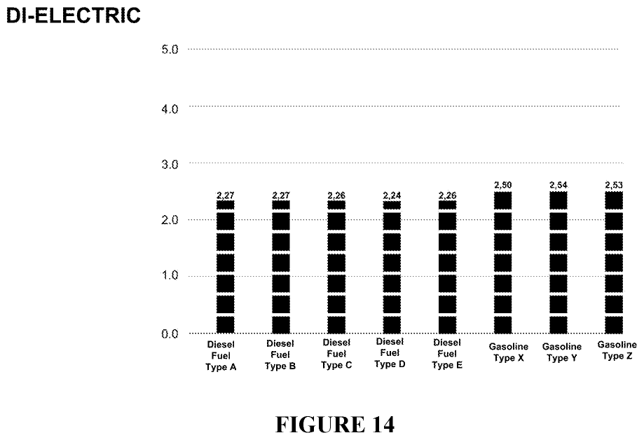

FIG. 15—The diagram showing the fuel type difference according to the density values taken from the sensor.

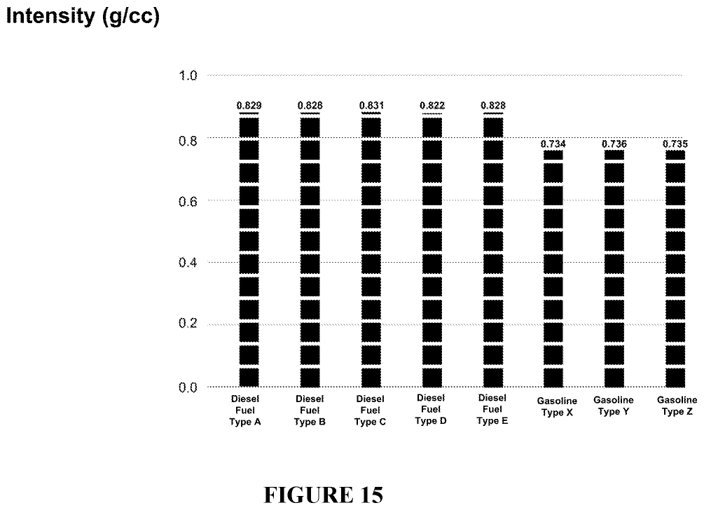

### DESCRIPTION OF REFERENCES

| NO | NAME OF PART |
|---|---|
| 100 | Liquid transfer flow line |
| 101 | Type detecting unit |
| 102 | Flow control unit |
| 200 | Fueling station |
| 201 | Vehicle |
| 202 | Fuel gun |
| 203 | Fuel dispenser |
| 204 | Monitoring screen |
| 205 | Device |
| 206 | Fuel transfer hose |
| 207 | Overflow bucket |
| 208 | Tanker adapter outlet |
| 209 | Fuel reservoir |
| 210 | Fuel storage tank |
| 211 | Fuel transfer tanker |
| 212 | Installation pipe |
| 213 | Control room |
| 301 | Transfer fuel |
| 302 | Transfer approved fuel |
| 303 | Inlet mouth |
| 304 | Outlet mouth |
| 401 | Sealing element |
| 402 | Groove |
| 403 | Protection cage |
| 404 | Vibration Arms |
| 405 | Flow direction |
| 502 | Motor |
| 503 | Data control unit |
| 504 | Sensor |
| 505 | Display screen |
| 506 | Battery |
| 507 | Magnet |
| 508 | Locking mechanism |
| 509 | Carrying arm |
| 510 | Elbow |
| 511 | Flow control pane |
| 512 | Gear group |
| 513 | Flow control valve |
| 514 | Float |
| 515 | Fueling mouth type identification detector |
| 516 | Float position sensor |
| 517 | Filling mouth |
| 518 | Transmitter |
| 519 | Buzzer |

The invention includes a device (205) which prevents the situations of fueling incorrect or poor-quality fuels to the tanks, during fueling to the storage tanks (210) at fueling stations (200), by analyzing fuel quality and fuel type considering many physical parameters with the help of a sensor (504) consist of mechanical resonators, and a smart fueling elbow which has mobile characteristics making possible for the user to carry the elbow to the usage field.

### DESCRIPTION OF THE INVENTION

The invention is used during the fuel transfer to the fueling station (200) of the fuel transfer tank (211) in a fueling station (200). The liquid transfer flow line (100) must be installed with the purpose of performing fuel transfer from the fuel transfer tanker (211) to the fuel storage tanks (210) at the fueling station (200). In this liquid transfer flow line (100), the fuel in the fuel reservoir (209) of the fuel transfer tanker (211) is connected to the fuel transfer hose (206), which will form the transfer line to be used in transfer to the tanker adapter outlet (208). The device (205) is installed at end of the fuel transfer hose (206) is connected to the tanker adapter outlet (208) of a fuel transfer tanker (211). The outlet mouth (304) of the fuel detection system is attached to the filling mouth (517) at the inlet of the fuel storage tank (210) in which the transfer is required.

At the fueling station (200), there may be more than one fuel storage tank (210). Accordingly, at the inlet of each fuel storage tank (210), a filling mouth (517) must be provided. These filling mouths (517) can be in the inside of the overflow buckets (207) as well as outside the overflow buckets (207). These fuel storage tanks (210) located in the station (200) are used for the storage of the fuel. The vehicle (201) to be filled with fuel in the fueling station (200) receives fuel through the fuel dispenser (203) from the fuel storage tanks (210) in which the fuel is stored. This fuel in the storage tanks (210) is connected to the fuel dispensers (203) which are used to supply the fuel with the installation pipelines (212).

The vehicle (201) to be filled with fuel stands next to the fuel dispenser (203) and performs fuel supply through the hose and the fuel gun (202) in the dispensers.

An intelligent fueling elbow is defined as the device (205) in the system. The device (205) has a locking mechanism (508) that allows easy connection. The carrying arm (509), which the device 205 possesses, is convenient for mobile use. The elbow (510) located in the device (205) allows the connection equipment to be used in fuel transfer to be more conveniently connected. The float (514) located on the device (205) allows the device (205) to change the sleep mode and initiate the analysis of the sensor (504). The float position sensor (516) on the device detects that the liquid transfer flow line (100) is filled with liquid.

The device (205) supplies energy that it needs by its long-life battery (506). Equipment such as sensors, detectors and the motor (502) located on the device (205) takes their energy needs from the battery located on the device (205).

When the motor (502) receives the command to move, it controls the flow control valve (513) via the gear group (512).

The device (205) located on the liquid transfer flow line (100) has a unit (101) for detecting the liquid quality and the type of liquid. The unit (101), which perceives the liquid quality and the type, decides whether or not the transfer should be performed by commanding the flow control unit (102) after evaluating the measurements.

In the device (205) of an implementation of the present invention, a liquid transfer flow line (100) is formed between the transfer fuel (301) to be transferred from the fuel reservoir (209) in the fuel transfer tanker (211), and the transfer approved fuel (302) which shall go to the fuel storage tank (210) where the fuel is stored in the fuel station (200).

Fuel transfer to the liquid transfer flow line (100) may be accomplished by a fuel transfer hose (206) or may be any means through which the fuel can pass. This liquid transfer flow line (100) has an inlet mouth (303) at one end and an outlet mouth (304) at the other end. This inlet (303) at one end of the liquid transfer flow line (100) is connected to the outlet of the reservoir (209) in the fuel transfer tank and a seal is provided here and the outlet mouth (304) at the other end of the liquid transfer flow line (100) is connected to the fuel storage tank (210) which is located in the fuel station (200) where the fuel is stored or to the device (205) which takes fuel or directly to the filling mouth at the inlet of the fuel storage tank (210) and a seal is formed here as well.

A device (205) is located in the liquid transfer flow line (100) which provides fuel transfer between the fuel reservoir (209) of the fuel transfer tanker and the fuel storage tank (210) of the fuel station (200). This device (205) is easily capable of being mounted on any preferred portion of the liquid transfer flow line (100) since the fuel flow rate and/or total amount passing through the entire liquid transfer flow line (100), the nature of the fuel, and thus the technical characteristics will not change. In the case where the flow control unit (102) is provided in the liquid transfer flow line (100), all the fuel passing through the liquid transfer flow line (100) passes through this device (205) as well.

The liquid flow can be observed from the flow control pane (511) during transfer. The transferred fuel can be visually inspected through the flow control pane (511) on the device (205).

In the device (205), there is a sensor (504) which detects the type of fuel (gasoline, diesel fuel, etc.) and the quality of the fuel passing through the flow control unit (102). When the fuel enters in the device (205), the sensor (504) is able to detect the nature of the fuel from the viscosity, density dielectric, and temperature values of the fuel. The sensor (504) transmits this information from the fuel directly to the data control unit (503).

The device (205) also includes a flow control valve (513) which inhibits fuel transfer or permits the transfer of fuel if allowed. The flow control valve (513) controls the passage of the fuel passing through the device (205) via the data control unit (503) and prevents passage of the fuel or permits passage of the fuel according to the commands of the data control unit (503).

This flow control valve (513) in the device (205) is capable of completely stopping the flow according to the commands received from the data control unit (503) and not allowing the fuel flow to pass through the outlet mouth (304) at all. The closing and opening of the flow control valve (513) depends entirely on the commands received from the data control unit.

The filling mouth detection detector (515) located in the device (205) identifies the fuel type in the liquid transfer flow line (100) where the filling mouth (517) at the inlet of the fuel storage tank (210) to which the fuel is to be discharged, is defined. The nature of the filling mouth (517) at the inlet of the fuel storage tank (210) is determined by the help of the magnet (507) mounted on it. The pole position of the magnet (507) determines the type of filling mouth (517).

The transmitter (518) is located in the device (205) to transmit the entire or a part of the information collected in the data control unit (503) to a receiver located outside. The use and operation of the device (205) is performed as follows. The fuel transfer tanker (211), which replenishes various types of fuels from the refinery reservoirs (209), is provided for transferring this fuel to the fuel storage tank (210). A fluid transfer flow line (100) is formed between the reservoir (209) and the fuel storage tank (210) for carrying out this transfer. In order to form this liquid transfer flow line (100), the inlet mouth (303) at one end of the flow line is mounted at the tanker adapter outlet (208) located in the fuel transfer tanker (211). The filling mouth (517) at the other end of the liquid transfer flow line (100) is installed in one of the fuel storage tanks (210) in the fueling station (200). Thereby, a liquid transfer flow line (100) is formed between the reservoir (209) and the fuel storage tank (210). In this liquid transfer flow line (100), a device is present (205). If it is preferred to transfer the fuel through the liquid transfer flow line (100), the flow control element within the device (205) opens the flow path and proceeds through the fuel inlet mouth (303) and within the liquid transfer flow line (100) all the way to the device (205). The flow control valve (513) in the device (205) does not allow for the flow in its initial position. For this reason, the fuel can only flow until into the device (205). When the fuel enters the device (205), the sensor (504) detects the type of the fuel (gasoline, diesel fuel, etc.) and transmits it to the data control unit (503) and make it possible for the data control unit (503) to identify the fuel. In this time slot, the detector (515) also communicates with the filling mouth (517) on which the magnet (507) is mounted on the fuel storage tank (210) to which the outlet mouth (304) is connected. In each fuel storage tank (210) located at the fueling station (200) there is a filling mouth (517) on which the magnet (507) is mounted and the outlet mouth (304) knows only the fuel type of the fuel storage tank (210) on which it is mounted. By this way, the filling mouth type determination detector (515) can identify which fuel storage tank (210) is in contact with and obtain information on which fuel is contained in the fuel storage tank (210). Subsequently, the data control unit (503) communicates with the detector (515) and receives information from the filling mouth determination detector (515) that the outlet mouth (304) is connected to which fuel storage tank (210). The data control unit (503) compares the fuel type information received from the sensor (504) with the fuel type information received from the detector (515) and if the two pieces of information match each other, then the flow control valve (513) sends a command to make open the flow control valve (513) and allowing for the transferring of the fuel within the liquid transfer flow line (100). However, if the data control unit (503) determines that the information of the two sides are different from each other as a result of this comparison, in this case, it does not send any command to the flow control valve (513) and provides audible and visual warnings while preventing the flow. The visual warning is displayed on the display screen (505) with the led lights on. The audible warning is given by the buzzer (519) in the device (205). If preferred, it can report the information via the transmitter (518) to the fuel transfer monitoring screen (204) in the control room (213) in the fueling station (200) where the fuel is transferred or to any receiver in the external environment. After the audible and visual warnings for the employee who is performing the task, the outlet mouth (304) is mounted to another fuel storage tank (210) by the employee. In this situation, the detector (515) communicates with the filling mouth (517) in the new fuel storage tank (210) where the outlet mouth (304) is installed, and acquires the knowledge of the fuel type in the fuel storage tank (210). This information is transmitted to the data control unit (503). The data control unit (503) compares this new information received from the detector (515) with the information received from the sensor (504) and allows that the flow control valve (513) to flow by sending a command to the flow control valve (513) if the two pieces of information match each other. All information transmitted to the data control unit (503) and transmitted to the other units from the data control unit (503) can be transmitted and reported through the transmitter (518) to the external environment.

The sensor (504) can directly and simultaneously measure the viscosity, density, dielectric constant and temperature of the liquids.

As an advantageous point, the sensor (504) monitors the direct and dynamic relationship between the multiple physical properties to determine the quality of the fluids, the condition, and the pollutant load.

The sensor (504) is mounted on the device (205) with grooves (402). The sealing element (401) on the sensor (504) provides sealing. The vibration arms (404) of the sensor (504) are protected by the protection cage (403).

In the present invention, the communication of the sensor (504) is preferably achieved easily with the protocol compatible with Universal CAN J1939. Other communication protocols known and used in the state of art can also be applied.

The vibrating arms (404) on the sensor (504) are excited by a piezoelectric drive. The sensor (504) detects by a resonant piezo electronic element that is emerged on the vibrating arms (404). The voltage magnitude applied to the piezo electronic element is proportional to the pressure applied to the vibrating arms (404) on the sensor (504).

The vibrating arms (404) on the sensor (504) vibrate steadily at the natural frequency during operation.

The sensor (504), which identifies the liquid type and quality of the fluid driven by the piezoelectric method, is mounted with grooves (402) in which it has the measurement area, and then an alternative power to the sensor (504) is transmitted so as to make it possible that the actuator can provide vibration in line with its natural frequency. When the sensor (504) is in contact with the liquid, the frequency of the sensor (504) is changed by changing the mass loaded on the vibrating arms (404). The intensity of the liquid being measured is determined by measuring changes in the detector natural frequency or vibration cycle by the detector which measures the change in vibration frequency occurring in the vibration arms (404) on the sensor (504).

It consists of the sensor (504) unit and closed loop control unit. Sensor unit is consist of the actuator, vibrating arms (404) and detector. The vibrating arms (404) directly detects the liquid density and the detector transmits the signal carrying measurement information to the closed loop control unit for processing and output intensity value. The closed-loop control unit generates an excitation signal to control the actuator and then drives the sensor (504).

The temperature changes affect the elastic modules of the vibrating arms (404) located on the sensor (504) and since the vibrating arms (404) directly affect the natural frequency of the vibrating arms (404), the instantaneous temperature measuring sensor (504) on the sensor 504 is present. As an advantageous point, the temperature compensates for changes in the elasticity modules occurring on the sensor (504).

When the sensor (504) is excited by its alternating current at its resonance frequency, the measured electric current reaches the speed of oscillation of the vibration fork (404). When vibrating at low amplitudes, only “1D linear harmonic oscillator” is taken, taking into account only the peaks of the oscillating ends. The sensor calculates the density, viscosity and dielectric constant according to the instantaneous temperature value.

Aforementioned sensor (504), the probe containing a mechanical resonator, is used to determine various properties (e.g., molecular weight, viscosity, specific weight, elasticity, dielectric constant, conductivity, etc.) of the individual liquid elements in a liquid composition.

The frequency response of the resonator is measured, preferably as a function of time, for the liquid under the test. Resonator properties can be calibrated to a known standard liquid to determine the properties of a fluid whose properties are unknown.

The sensor (504) uses a method comprising a mechanical piezometric quartz resonator (mechanical resonator) to measure physical and electrical properties, such as viscosity density, dielectric constant, and conductivity of liquid components in the combinatorial chemistry processes. The mechanical resonator is connected to a measuring circuit which transmits a variable frequency input signal, such as a sinusoidal wave, which travels at a predetermined frequency range. The resonator response on the frequency range is monitored to determine the selected physical and electrical characteristics of the tested liquid.

The resonator responses from all the resonators in the sensor (504) can then be used to obtain additional information about the tested compound. The response of the resonator varies depending on the viscosity, density and dielectric constant, and the conductivity of the liquid can affect the response of the resonator.

The resonator connected to an input signal source is placed in each liquid composition and a variable frequency input signal which causes the resonator to vibrate is sent to each resonator. The input signal frequency is predetermined to create a unique resonator response for each particular liquid. The resonator response will also be different for each compound.

Although there is sufficient electrical connection between the resonator and the composition to measure the electrical properties of the compositions, a more detailed electrical connection may be required to more accurately measure the increased measurement accuracy.

In our invention, preferably, the resonator in the sensor (504) is preferably made of a quartz crystal. The vibrator bars of the resonator swing in the opposite direction and each rod acts as a separate potential acoustic wave generator. In other words, the bars approach each other or move away from each other.

However, the bars vibrate in opposite directions and in opposite phases, so that the locally generated waves of each bar tend to cancel each other, which causes the resonator to form almost no acoustic wave.

The resonator is preferably combined with an oscilloscope, which transmits a resonant variable frequency input signal to produce resonator oscillations and receive the resonator response at different frequencies. Before starting the measurement on the broadband, the output of the resonator outlet goes through the amplifier.

The resonator system is used to monitor the average molecular weight of polystyrene in toluene solutions during the polymerization reaction. The resonator is typically connected to a probe and probe collects the data by scanning the samples. The oscilloscope is used to stimulate resonator oscillations and to take the oscillator's response at various frequencies.

The resonator response is then recorded as a function of the excitation frequency. The test conditions remained stable throughout all experiments. Environment temperature and test conditions are almost the same. The increased sensitivity of the resonator causes slight differences in chemical structure which causes significant differences in the resonator response. Since the signals generated by the resonator are very distinct and having intervals, they are easier to be analyzed and to be compared.

1. The present invention is related to a system for identifying the passage of the fuel during fueling and characterized by;
A sensor (504) which determines the type and quality of the liquid and transmits the generated data to the data control unit (503) by a probe piezoelectric method which includes a mechanical resonator that directly and simultaneously measures the viscosity, density, dielectric constant and temperature of the liquid,
A data control unit (503), which blocks the passage of the fuel or permits the passage of the fuel according to its commands, receiving the information of the fuel directly from the sensor (504),
A flow control valve (513), which allows or prevents the flow of fuel in situations where it is identified that the results of the comparison revealed a difference or equality in terms of information between the sensor (504) and the data control unit (503) which receives data from the sensor (504),
A locking mechanism (508), which allows for easy connection of the device (205), which is defined as a smart fueling elbow,
A carrying arm (509) on the device (205), which is defined as a smart fueling elbow, providing the mobile characteristic to the device (205) for easy transportation by the user to the place of use,
A battery (506) which allows the device (205) to operate independently in a mobile manner and fulfill the energy needs of the devices such as sensors, detectors and motor (502) which are located on the device (205) that is defined as a smart fueling elbow.

2. The device (205) according to claim 1 is characterized by a transmitter (518) that allows all information, which are transmitted from the data control unit (503) to the other units, to be transferred to the external environment and to be reported.

3. The device (205) according to claim 1 is characterized by a flow control pane (511), which is located on the transferred fuel device (205), providing visual control capability.
